(19) United States
(12) Patent Application Publication
(10) Pub. No.: US 2022/0332339 A1
(43) Pub. Date: Oct. 20, 2022

(54) METHOD FOR PERCEIVING AN AUGMENTED REALITY FOR AN AGRICULTURAL UTILITY VEHICLE

(71) Applicant: DEERE & COMPANY, MOLINE, IL (US)

(72) Inventors: NORBERT FRITZ, Ilvesheim (DE); Stephan Denker, Karlsruhe (DE)

(21) Appl. No.: 17/656,132

(22) Filed: Mar. 23, 2022

(30) Foreign Application Priority Data
Apr. 14, 2021 (DE) 102021109330.9

(51) Int. Cl. B60W 50/14; B60K 35/00; G02B 27/01; G06T 19/00

(52) U.S. Cl. CPC B60W 50/14; B60K 35/00; G02B 27/017; G06T 19/006; B60W 2050/146; B60W 2300/15; B60W 2556/35; B60K 2370/177; B60K 2370/184; B60K 2370/334; B60K 2370/785

(57) ABSTRACT

A method for perceiving an augmented reality during a work assignment of an agricultural utility vehicle includes processing data of a data communication system of the agricultural utility vehicle via a control unit, sending the data processed via the control unit to a perception device, projecting the data received from the control unit as an item of optical information via a perception device, and jointly perceiving the real surroundings of the agricultural utility vehicle and the projected optical information via the perception device

### CROSS-REFERENCE TO RELATED APPLICATIONS

This application claims priority to German Patent Application No. 102021109330.9, filed Apr. 14, 2021, the disclosure of which is hereby incorporated by reference.

### FIELD OF THE DISCLOSURE

The present disclosure relates to a method for perceiving an augmented reality for an agricultural utility vehicle.

### BACKGROUND

The quantity of data to be processed is becoming greater and greater in the preparation and performance of agricultural work assignments. The user or vehicle driver of the agricultural utility vehicle is accordingly confronted with increasingly more complex handling of extensive items of information and data during his actual agricultural activity.

### SUMMARY

It is therefore the object of the present disclosure to relieve an agricultural work assignment with respect to the data management. This object is achieved by a method having one or more of the following features. Further advantageous embodiments of the method according to the disclosure are disclosed herein.

According to some embodiments, the method enables the perception of an augmented reality during a work assignment of an agricultural utility vehicle (e.g., tractor, harvester). For this purpose, data of a data communication system (for example, a CAN bus) of the agricultural utility vehicle are processed in a control unit. This control unit sends processed data to a perception device. For example, the control unit sends the processed data as optical data (for example, image data) to the perception device.

The perception device projects data received from the control unit as an item of optical information. The projection takes place in such a way that by means of, or via, the perception device, the real surroundings of the agricultural utility vehicle and the projected optical information are perceptible jointly for an observer (for example, the driver of the agricultural utility vehicle).

In this way, many additional items of information, such as agronomic data, can be overlaid in the field of view of the driver during the agricultural work assignment of the utility vehicle. The items of information can be registered faster and more efficiently in this way. The user or driver is distracted less, since the user or driver no longer has to register (for example, view or read) the desired or required items of information at various display units, displays, or the like, which are distributed in the driver's cab. This can also avoid possible premature fatigue.

Therefore, the decisions required on the basis of the registered data can be made free of stress during the work assignment. The actual agricultural work assignment can be carried out significantly more comfortably and efficiently. A communication with third parties required during the work assignment can also be carried out more easily and efficiently by means of, or via, the method. Overall, the work quality during the work assignment and the general work productivity increase.

The projection technology for projecting the items of optical information can also be used to project a virtual user interface (e.g., virtual display and/or operating unit for inputting and/or selecting and/or displaying data) in front of the eyes of the user. Virtual manual command inputs on this virtual user interface by the user can be registered by means of, or via, a suitable sensor system, which is arranged, for example, on the perception device itself.

The above-mentioned virtual user interface can also be used for the display and processing of data or items of information of a mobile terminal (for example, a smart phone, tablet, etc.) of the user. For this purpose, the mobile terminal has a data connection either to the data communication system or directly to the control unit. The control unit then generates the optical data for the virtual user interface.

Alternatively, the control unit can depict the data or items of information of the mobile terminal on a user interface that is physically present in the agricultural utility vehicle.

In some embodiments, the perception device has a personally wearable viewing unit (for example, a glasses-like device, viewing panel wearable on the head, etc.). For example, the perception device includes such a viewing unit. The personally wearable properties of the viewing unit enable flexible data management for the user during the work assignment.

Alternatively, or additionally, the perception device has a viewing panel (for example, a windshield) of a cab of the utility vehicle. For example, the perception device includes such a viewing panel. Such a viewing panel acts in an additional function as a comfortable information surface, the items of information of which can be incorporated into the real surroundings perceived by the user.

The data connection between the data communication system of the agricultural utility vehicle and the perception device by means of, or via, the control unit enables a comfortable optical representation of a large number of different types of data for the user or driver. In some embodiments, the data communication system contains at least one of the following groups of data:

Agronomic data, which represent agronomic features of the present geographic usage region of the utility vehicle. These are, for example, data or maps of the field presently to be treated and directly adjacent fields, for example with respect to the topography, the last harvest, the last field or weed treatment, the plant growth, the moisture, the nutrient supply, or the type of soil.

Work data, which represent features of the present work assignment of the utility vehicle. These are, for example, data or maps with respect to the field boundaries of the present field to be treated or an already treated field or field section, a preplanned work route for the utility vehicle, or specific work specifications for the work assignment.

Logistics data, which represent features of at least one object or obstacle in the present geographic usage region. These are, for example, data or maps with respect to a real-time locating and status information of cooperating agricultural utility vehicles, possible obstacles in the present work region, impassable regions in the present work region, or roads, paths, or buildings in the present work region.

Position data, which represent a geographic position of the utility vehicle. These are data of a GPS receiving antenna, for example.

Orientation data, which represent an orientation of the utility vehicle or its driver's cab relative to the present geographic usage region, for example relative to a reference straight line (for example, Earth's horizon) or reference plane (for example, Earth's horizon plane) in the usage region. These are, for example, data of a sensor system having one or more inclination sensor(s) on the utility vehicle, which register an orientation or inclination of the vehicle cab or the utility vehicle in the usage region (field, farmland, etc.).

Location data, which represent a location of the perception device relative to the utility vehicle or to the vehicle cab. These are, for example, data of a sensor system which enables tracking of the present location (for example, position and/or orientation or inclination) of the perception device relative to the utility vehicle, for example to the vehicle cab. In this way, changes of the working position of the user can be taken into consideration in the projection of the items of optical information.

Processing the above-mentioned data and displaying them as items of optical information by means of, or via, the perception device offers significant assistance for the data management during a present work assignment using the agricultural utility vehicle.

For example, objects of interest can be displayed during the work assignment (e.g., cooperating utility vehicles, obstacles). They can be optically highlighted, for example, by means of, or via, a projected color change of the relevant object. A projected optical marking can represent an object and can be projected in such a way that the projection position corresponds from the viewpoint of the user or observer to the actual position in the real surroundings. Various objects can be projected as different markings (e.g., different colors, geometries, symbols). This helps the worker to have precise knowledge about the position of relevant objects even in difficult viewing conditions (e.g., at night, fog, dust).

The above-mentioned optical markings can contain additional items of information. These are, for example, important items of status information of the respective object (e.g., fill level of a harvesting container, technical problems).

Moreover, it is possible on the basis of the mentioned data processing to project features and items of information of the present work assignment. For example, the worker can observe virtual lines or curves which represent the boundaries of the present work region (for example, grain field, farmland, etc.). A preplanned or proposed work route for the utility vehicle can also be displayed in this way.

During night work, it is possible to significantly enlarge the perceptible surroundings within the present work field in comparison to night lighting by the working utility vehicle. For this purpose, for example, tracks, roads, field contours, and the surrounding horizontal silhouette are projected.

As already mentioned, specific data of the data communication system are processed in the control unit. In some embodiments, during this data processing, individually selected data are assigned supplementary geo-reference data (for example, a topographic data), which represent a real geographic position of the optical information to be projected. In some embodiments, the geo-reference data are also contained in the data communication system and are easily accessible in terms of data for the control unit in this way.

Geo-reference data can be generated on the basis of position data which originate, for example, from a position detection system (for example, GPS) and are available in the data communication system. Moreover, for example, already existing or stored and retrievable digital topographic maps can be used as geo-reference data, which contain, for example, surface shapes.

The use of the geo-reference data enables a geographic differentiation of various data which are to be projected as different items of optical information. For example, by means of, or via, the geo-reference data, geographically different items of optical information can be projected as a different spatial relative arrangement with respect to the perception device. The observer of the perception device then receives a three-dimensional impression of the items of optical information and can therefore register them even more easily.

Various agronomic data or maps can be projected using geo-reference data and perceived as a three-dimensional representation in this way. Equal values within the displayed specific agronomic data can be projected, for example, having the same color on the basis of a color scheme. In some embodiments, the user can select via a user interface (for example, input and display unit) which agronomic data or which agronomic map are to be projected.

The control unit can be arranged completely inside or outside the agricultural utility vehicle. Alternatively, the control unit can be provided functionally and physically distributed partially inside and partially outside the utility vehicle.

In some embodiments, the control unit is arranged completely inside the agricultural utility vehicle. For example, the control unit can be inexpensively provided as a component of an internal-vehicle control system.

In some embodiments, the control unit is arranged completely outside the agricultural utility vehicle. For example, this external control unit is integrated into a stationary control center (e.g., computer, processing center, server). The data of the data communication system are then sent to the stationary control center and processed therein. The processed data are sent back to the perception device for the projection.

In some embodiments, to carry out the method in a technically efficient manner, the agricultural utility vehicle is equipped with suitable sensors. For example, one or more inclination sensors are provided, on the basis of which the present orientation or inclination of the utility vehicle during the work assignment (for example, on the farmland or grain field) is detected relative to a reference straight line (for example, Earth's horizontal) or reference plane. Moreover, the utility vehicle can contain a sensor system which enables tracking of the present location (for example, position and/or orientation and/or inclination) of the perception device relative to the vehicle cab. In some embodiments, the utility vehicle has a receiving antenna (for example, a GPS receiver) for receiving the present position of the receiving antenna or the utility vehicle. The receiving antenna can then provide its present position data to the data communication system.

The method according to the disclosure is explained in more detail hereinafter on the basis of the attached drawing.

The above and other features will become apparent from the following detailed description and accompanying drawings.

### BRIEF DESCRIPTION OF THE DRAWINGS

The detailed description of the drawings refers to the accompanying FIGURES in which:

FIG. 1 schematically shows components of an agricultural utility vehicle, which has a data communication system, according to an embodiment.

Like reference numerals are used to indicate like elements throughout the several FIGURES.

### DETAILED DESCRIPTION

The embodiments or implementations disclosed in the above drawings and the following detailed description are not intended to be exhaustive or to limit the present disclosure to these embodiments or implementations.

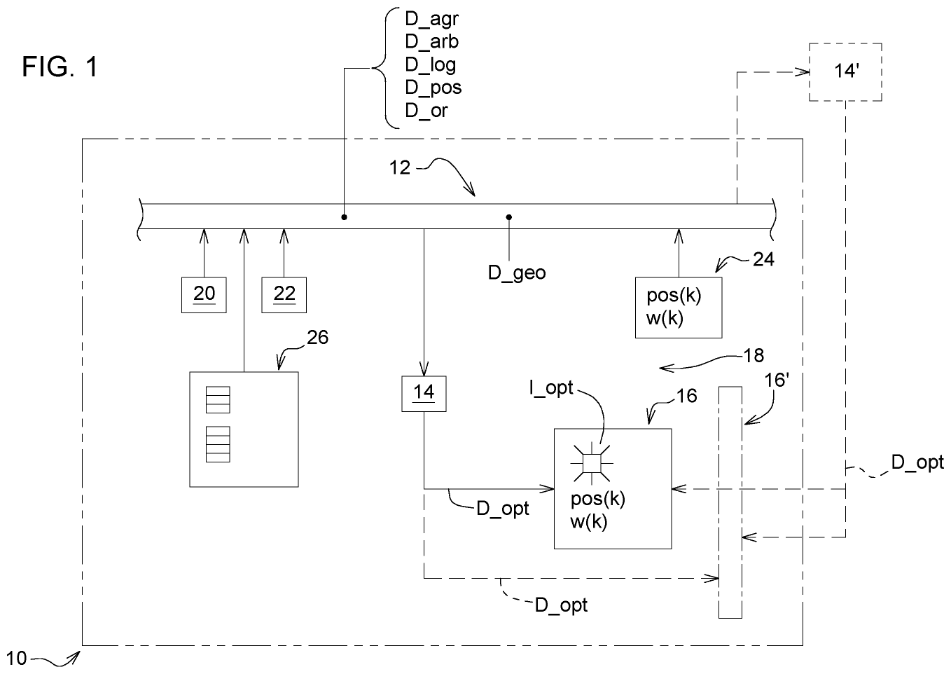

FIG. 1 schematically shows components of an agricultural utility vehicle 10 (in short utility vehicle 10 hereinafter), which has a data communication system 12. In some embodiments, the data communication system 12 is designed as a bus system (e.g., ISO, CAN). Various data of the data communication system 12 are processed in a control unit 14 and sent as optical data D_opt to a perception device 16.

The perception device 16 is designed as a viewing unit (for example, special glasses) personally wearable by the user or driver and is only schematically shown here. The perception device 16 projects optical data D_opt received from the control unit 14 as items of optical information I_opt in such a way that the user (for example, a vehicle driver) perceives the real surroundings of the utility vehicle 10 and the item(s) of optical information I_opt jointly by means of, or via, the perception device 16.

Alternatively, or additionally, a perception device 16′ is provided. It is designed as a viewing panel of a vehicle cab 18 of the utility vehicle 10 and is schematically shown by dashed lines. The viewing panel 16′ is for example a windshield of the vehicle cab 18. If the viewing panel 16′ is used as the perception device, it receives optical data D_opt from the control unit 14 and projects the optical data D_opt as items of optical information I_opt.

In the illustrated embodiment, the control unit 14 is integrated inside the utility vehicle 10. The control unit 14 is designed here, for example, as a microprocessor unit or the like.

Alternatively, the control unit 14 is replaced or supplemented by a control unit 14′ arranged externally with respect to the utility vehicle 10. In some embodiments, this external control unit 14′ is indicated by dashed lines and is a component of a stationary control center. The external control unit 14′ fundamentally operates like the internal control unit 14, i.e., various data of the data communication system 12 are processed in the control unit 14′ and sent as optical data D_opt to the perception device 16 and/or 16′.

Different data and/or data groups are available on the data communication system 12. D_agr denotes agronomic data which represent agronomic features of the present geographic usage region of the utility vehicle 10. D_arb denotes work data which represent features of the present work assignment of the utility vehicle 10. D_log denotes logistics data which represent features of at least one object (for example, further working utility vehicles or obstacles) in the present geographic usage region. D_pos denotes position data, which represent a geographic position of the utility vehicle 10. For this purpose, the data communication system 12 can access the data of a position antenna 20 (for example, a GPS receiver) of the utility vehicle 10. D_or denotes orientation data, which represent an orientation (e.g., location, inclination) of the utility vehicle 10 or its vehicle cab 18 relative to the present geographic usage region. For this purpose, the data communication system 12 can access the data of a sensor system 22. The sensor system 22, for example, contains one or more inclination sensor(s).

By means of, or via, a suitable location sensor system 24, a present relative location of the perception device 16 relative to the vehicle cab 18 is registered and passed on as location data to the data communication system 12. In some embodiments, the location data contain a position pos(k) and an orientation or an angle of inclination w(k) of the perception device 16 relative to the vehicle cab 18.

Furthermore, geo-reference data D_geo (for example, data from digital topography maps) are applied to the data communication system 12, which are also processed in the control unit 14 and assist a three-dimensional representation of various items of optical information I_opt. For this purpose, for example, the data D_agr, D_arb, and D_log can be assigned specific geo-reference data D_geo. The user can select at a user interface 26, for example, which agronomic data or which agronomic data map is to be processed in the control unit 14 or 14′ and is to be three-dimensionally projected by means of, or via, assigned geo-reference data D_geo.

The terminology used herein is for the purpose of describing example embodiments or implementations and is not intended to be limiting of the disclosure. As used herein, the singular forms “a,” “an,” and “the” are intended to include the plural forms as well, unless the context clearly indicates otherwise. It will be further understood that the any use of the terms “has,” “includes,” “comprises,” or the like, in this specification, identifies the presence of stated features, integers, steps, operations, elements, and/or components, but does not preclude the presence or addition of one or more other features, integers, steps, operations, elements, components, and/or groups thereof.

Those having ordinary skill in the art will recognize that terms such as “above,” “below,” “upward,” “downward,” “top,” “bottom,” etc., are used descriptively for the FIGURES, and do not represent limitations on the scope of the present disclosure, as defined by the appended claims. Furthermore, the teachings may be described herein in terms of functional and/or logical block components or various processing steps, which may be comprised of any number of hardware, software, and/or firmware components configured to perform the specified functions.

Terms of degree, such as “generally,” “substantially,” or “approximately” are understood by those having ordinary skill in the art to refer to reasonable ranges outside of a given value or orientation, for example, general tolerances or positional relationships associated with manufacturing, assembly, and use of the described embodiments or implementations.

As used herein, “e.g.,” is utilized to non-exhaustively list examples and carries the same meaning as alternative illustrative phrases such as “including,” “including, but not limited to,” and “including without limitation.” Unless otherwise limited or modified, lists with elements that are separated by conjunctive terms (e.g., “and”) and that are also preceded by the phrase “one or more of” or “at least one of” indicate configurations or arrangements that potentially include individual elements of the list, or any combination thereof. For example, “at least one of A, B, and C” or “one or more of A, B, and C” indicates the possibilities of only A, only B, only C, or any combination of two or more of A, B, and C (e.g., A and B; B and C; A and C; or A, B, and C).

While the above describes example embodiments or implementations of the present disclosure, these descriptions should not be viewed in a restrictive or limiting sense. Rather, there are several variations and modifications which may be made without departing from the scope of the appended claims.

What is claimed is:

1. A method for perceiving an augmented reality during a work assignment of an agricultural utility vehicle, comprising:
processing data of a data communication system of the agricultural utility vehicle via a control unit;
sending the data processed via the control unit to a perception device;
projecting the data received from the control unit as an item of optical information via a perception device; and
jointly perceiving the real surroundings of the agricultural utility vehicle and the projected optical information via the perception device.

2. The method of claim 1, wherein the perception device includes a personally wearable viewing unit.

3. The method of claim 1, wherein the perception device includes a viewing panel of a vehicle cab of the utility vehicle.

4. The method of claim 3, wherein the perception device includes a windshield of the vehicle cab.

5. The method of claim 1, wherein the data of the data communication system comprises at least one of the following data groups: agronomic data, which represent agronomic features of the present geographic usage region of the utility vehicle; working data, which represent features of the present work assignment of the utility vehicle; logistics data, which represent features of at least one object or obstacle in the present geographic usage region; position data, which represent a geographic position of the utility vehicle;
orientation data, which represent an orientation of the utility vehicle relative to the present geographic usage region; and location data, which represent a location of the perception device relative to the utility vehicle.

6. The method of claim 1, wherein during the processing of the data via the control unit, individual data are assigned supplementary geo-reference data, which represent a real geographic position of the optical information to be projected.

7. The method of claim 6, wherein the optical information is projected based in part on the assigned geo-reference data as a three-dimensional relative arrangement with respect to the perception device.

8. The method of claim 1, wherein the control unit is integrated inside the utility vehicle.

9. The method of claim 1, wherein the control unit is arranged outside the utility vehicle.
